(19) United States
(12) Patent Application Publication
(10) Pub. No.: US 2016/0200187 A1
(43) Pub. Date: Jul. 14, 2016

(54) INERTIAL TWO POINTS SUPPORT TYPE ENGINE MOUNTING STRUCTURE

(71) Applicant: HYUNDAI MOTOR COMPANY, SEOUL (KR)

(72) Inventor: Seung-Won Kim, Seoul (KR)

(73) Assignee: HYUNDAI MOTOR COMPANY, SEOUL (KR)

(21) Appl. No.: 14/839,504

(22) Filed: Aug. 28, 2015

(30) Foreign Application Priority Data
Jan. 13, 2015 (KR) 10-2015-0004556

(51) Int. Cl. B60K 5/12; B60K 13/04; B60K 17/04; F01N 13/18

(52) U.S. Cl. CPC B60K 5/12; F01N 13/1805; B60K 13/04; B60K 17/04

(57) ABSTRACT

An inertial two points support type engine mounting structure of a vehicle using an inertial support type may include an engine mount which supports a first side of the engine, a transmission (TM) mount which supports a transmission connected to a second side of the engine, an exhaust system which is connected to the engine to perform a role of a roll rod, and a hanger mounted on the exhaust system.

### CROSS-REFERENCE TO RELATED APPLICATION

This application claims priority to Korean Patent Application No. 10-2015-4556 filed Jan. 13, 2015, the entire contents of which is incorporated herein for all purposes by this reference.

### BACKGROUND OF THE INVENTION

1. Field of the Invention

The present invention relates to an engine mount structure of a vehicle. More particularly, the present invention relates to an inertial two points support type engine mounting structure that improves the robustness of the system, and reduces the weight and cost of the vehicle, by utilizing an exhaust system structure to which a hanger is applied instead of a roll rod structure used for an inertial support type.

2. Description of Related Art

In general, a mount is installed around an engine so as to support the weight of the engine when transmitting the torque shaft rotational force of the vehicle engine to the driving force of the drive shaft, and such a mount performs the role of smoothly transmitting the output of the engine to the drive shaft by controlling the rotation force of the torque shaft of the engine.

An engine of a FF vehicle (a front-engine, a front-drive type) has characteristics in which a predominantly horizontal (lateral direction) mounting type and an inertial support type advantageous for an idling vibration performance are applied.

The inertial support type can be divided into a four points support type and a three points support type depending on the number of points to be supported, and in recent years, in most cases, a three points support type has been used from the viewpoint of weight and cost of the vehicle.

The Inertial three points support type is formed by a structure in which an engine mount and a transmission (TM) mount for supporting the majority of the power train weight are applied on the top of the side membrane one by one, and a roll rod (torque rod) for controlling the rotation behavior of the power train is inserted or forcibly press-fitted to a lower sub-frame.

The roll rod structure described above is essentially applied to such an inertial three points support type, and in order to equip the roll rod structure in the form of being inserted or forcibly press-fitted to the sub-frame, there is a problem in which the sub-frame needs to be manufactured in excessive weight and strength.

When the roll rod structure is inserted into the sub-frame, since the internal structure fails to form an end-closed structure and is opened, and at the same time, its rigidity is lowered depending on the size conditions of the roll rod structure, it is necessary to additionally apply a reinforcement plate. Further, when the roll rod structure is forcibly press-fitted to the sub-frame, since it is necessary to replace the sub-frame during after-service, there is a major disadvantage from the viewpoint of the weight and cost of the vehicle.

Thus, there is an intense desire for an engine mounting structure that is advantageous from the viewpoint of robustness of the system, while eliminating the problem of the excessive weight of the vehicle and an increase in costs.

The present invention has been made to solve the above-mentioned problems of the related art, and an object thereof is to provide an engine mounting structure that can reduce the weight of the vehicle, and simultaneously reduce the costs.

Further, another object of the present invention is to provide an engine mounting structure in which the load concentrated on one point of the roll rod is evenly distributed throughout the vehicle body, and the robustness is improved by connecting a plurality of hangers in parallel.

The technical problems to be solved by the present invention are not limited to the technical problem mentioned above, and another technical problem that has not been mentioned can be clearly understood by those skilled in the art from the description of the invention.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an inertial two points support type engine mounting structure of a vehicle to solve the above-described problems associated with prior art.

According to various aspects of the present invention, an inertial two points support type engine mounting structure of a vehicle using an inertial support type may include an engine mount which supports a first side of the engine, a TM mount which supports a transmission connected to a second side of the engine, an exhaust system which is connected to the engine to perform a role of a roll rod, and a hanger mounted on the exhaust system.

The hanger may be a bush anger in which an X-axis, a Y-axis, and a Z-axis have static characteristics and dynamic characteristics.

At least four or more hangers may be applied to the exhaust system.

The hanger may be applied to the exhaust system by fastening two points of the hanger to a floor panel of the vehicle by bolts.

Each hanger may be formed of a rubber material.

The hanger may include a “W”-shaped housing, and a circular fixing portion disposed inside the housing, and the fixing portion may be connected and fixed to both vertical inner sides of the housing via extension portions formed on both sides.

The present invention has an effect of reducing the weight and the cost of the vehicle, by applying the inertial two points support type engine mounting structure in which one point is removed compared to conventional inertial three points support type.

In addition, there is an effect of enhancing the degree of freedom in tuning by providing the roll rod type exhaust system, and an effect of improving the driving and handling performance due to a decrease in amount of behavior associated with an increase in roll stiffness.

Also, by applying a large number of hangers to the exhaust system, there are effects such as the simple structure and the improved robustness.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of an exemplary inertial two points support type engine mounting structure according to the present invention.

FIG. 2 is a side view of an exemplary inertial two points support type engine mounting structure according to the present invention.

FIG. 3 is a perspective view of a hanger applied to the exemplary inertial two points support type engine mounting structure according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention for improving the robustness of the system and for reducing the weight and cost of the vehicle by utilizing the exhaust system structure to which the hangers is applied instead of the roll rod structure is configured to include an engine mount 100 which supports one side of the engine, a transmission (TM) mount 200 which supports the transmission connected to the other side of the engine, an exhaust system 300 connected to the engine to perform the role of the roll rod, and a hanger 400 mounted on the exhaust system.

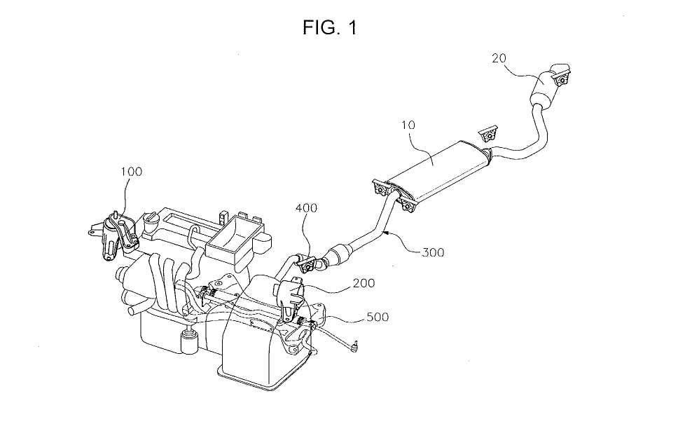

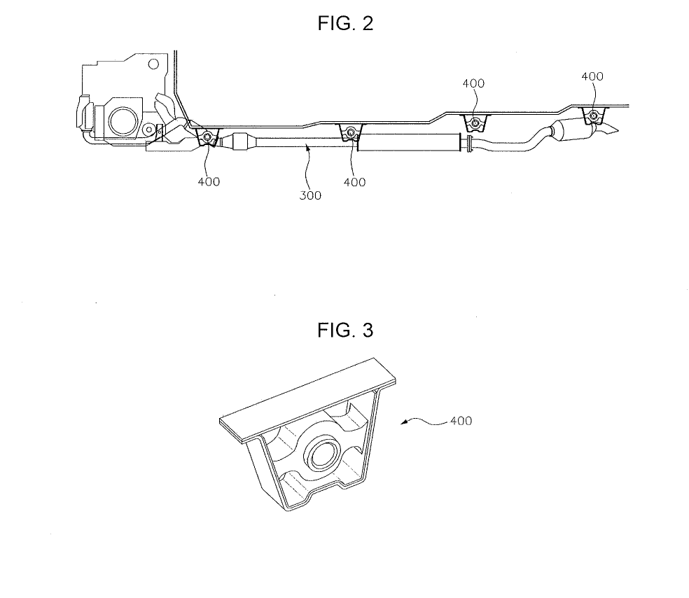

As the content thereof, FIG. 1 illustrates a perspective view of an inertial two points support type engine mounting structure according to various embodiments of the present invention, and FIG. 2 illustrates a side view of the inertial two points support type engine mounting structure according to various embodiments of the present invention.

As illustrated in the drawings, one point of the inertial two points support type engine mounting structure of the present invention corresponds to an engine mount 100 which supports the one side of the engine, and the other point corresponds to the TM mount 200 which supports the transmission connected to the other side of the engine.

Moreover, in the present invention, the exhaust system 300 plays the role of the roll rod in the existing inertial three points support type. The exhaust system is connected from the engine, and means a structure in which a manifold engine, a muffler 10, and a catalytic converter 20 are connected by an exhaust pipe.

It is a matter of course that devices may be added to or removed from the exhaust system 300 depending on the purpose and characteristics of the vehicle.

On the other hand, in order to support the exhaust system 300, although the hangers 400 are applied the exhaust system, unlike the hanger used in the existing exhaust system, the hangers of the present invention correspond to the bush type hangers in which an X-axis, a Y-axis, and a Z-axis have static characteristics and dynamic characteristics.

In connection with the hangers, FIG. 3 illustrates a perspective of the hanger applied to the inertial two points support type engine mounting structure according to various embodiments of the present invention.

Along the axial direction, the numbers of the static characteristics and dynamic characteristics of the hanger 400 are as follows. In the case of the X-axis, the static characteristics are 1.20 kgf/mm (direction ratio 0.84) and the dynamic characteristics are 1.68 kgf/mm (dynamic ratio 1.4). In the case of the Y-axis, the static characteristics are 5.12 kgf/mm (direction ratio 3.57) and the dynamic characteristics are 7.16 kgf/mm (dynamic ratio 1.4). In the case of the Z-axis, the static characteristics are 1.43 kgf/mm (direction ratio 1) and the dynamic characteristics are 2.00 kgf/mm (dynamic ratio 1.4). Similarly, it is possible to use a hanger with the different static characteristics and/or dynamic characteristics as needed.

As a comparison target thereof, the existing hanger has no characteristic due to the rotation of both the X-axis and Y-axis, and only has the static characteristics of 1.56 kgf/mm, and the dynamic characteristics of 2.96 kgf/mm in the Z-axis. That is, the existing hanger has a configuration that can be supported only in the Z-axis direction, and only plays the role of hanging the muffler 10.

Therefore, the hanger 400 of the present invention has the characteristics that can more efficiently support the role performance of the roll rod of the exhaust system 300 as compared to the existing hanger and in which the dynamic characteristics of the Z-axis is reduced as compared to the existing hanger, and noise, vibration and harshness of the vehicle are further reduced.

Moreover, at least 4 or more hangers 400 may be applied to the exhaust system 300. As illustrated in FIG. 1 and FIG. 2, although it is removed in the present invention, at a position where a bellows has been conventionally mounted, the hanger can be mounted at the front and rear of the muffler 10 and at the rear of the catalytic converter 20 to support the exhaust system. However, the more hangers may be disposed at various positions for the implementation of the more robust system so as to support the exhaust system.

In the previous inertial three points support type, if one point of the roll rod is damaged, the behavior of the vehicle becomes difficult. However, since several hangers 400 applied to the exhaust system of the present invention 300 are connected in parallel to control the behavior of the engine in the roll direction, except an extremely rare case where all the configurations are damaged at the same time, there are characteristics in which the robustness is further improved compared to the existing engine mounting structure.

On the other hand, the hanger 400 includes a “W”-shaped housing, and a circular fixing portion disposed inside the housing, wherein the fixing portion is preferably connected and fixed to both vertical inner sides of the housing via the extension portions formed on both sides. Moreover, by fastening the two points of the hanger to the floor panel of the vehicle by bolts, the fixing portion can be applied to the exhaust system 300, and thus, there is an advantage in which the application of hanger is very easy. By forming the material by a rubber, it is possible to maintain the aforementioned characteristics resistant to the noise, vibration and harshness.

The indoor vibration values of similar level compared to the substantially mass production vehicle have been checked through the experiment (a target value is 104 dB, an actual value is 105 dB), and a hanger insulation rate of 30 dB or more has been secured in the area of 3,000 rpm to 5,000 rpm in which the indoor contribution is large.

Also, as the sub-frame 500 becomes free from the insertion and forced press-fit of the roll rod, except for the upper gearbox portion, it is possible to reduce its size and to remove the inner reinforcing plate and reduce the thickness. Accordingly, the effect is enhanced in terms of the weight and costs.

Consequently, the present invention has advantages in which, by applying the inertial two points support type engine mounting structure in which one point is removed compared to the existing inertial three points support type, the weight and costs of the vehicle are reduced, the degree of freedom of tuning increases by providing the roll rod type exhaust system 300, and in the running and handling performance are improved due to a decrease in the amount of behavior associated with the increase in roll stiffness.

Also, it has an advantage in which its structure is simple and robustness is improved, by applying a number of hangers 400 to the exhaust system 300 in parallel.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An inertial two points support type engine mounting structure of a vehicle using an inertial support type, comprising:
an engine mount which supports a first side of the engine;
a transmission (TM) mount which supports a transmission connected to a second side of the engine;
an exhaust system which is connected to the engine to perform a role of a roll rod; and
a hanger mounted on the exhaust system.

2. The inertial two points support type engine mounting structure of claim 1, wherein the hanger is a bush anger in which an X-axis, a Y-axis, and a Z-axis have static characteristics and dynamic characteristics.

3. The inertial two points support type engine mounting structure of claim 1, wherein at least four or more hangers are applied to the exhaust system.

4. The inertial two points support type engine mounting structure of claim 3, wherein the hanger is applied to the exhaust system by fastening two points of the hanger to a floor panel of the vehicle by bolts.

5. The inertial two points support type engine mounting structure of claim 3, wherein each hanger is formed of a rubber material.

6. The inertial two points support type engine mounting structure of claim 1, wherein the hanger includes:
a “W”-shaped housing; and
a circular fixing portion disposed inside the housing, and
wherein the fixing portion is connected and fixed to both vertical inner sides of the housing via extension portions formed on both sides.
